(19) United States
(12) Patent Application Publication
(10) Pub. No.: US 2024/0352792 A1
(43) Pub. Date: Oct. 24, 2024

(54) LADDER AND ENTERTAINMENT COMBINATION SYSTEM

(71) Applicant: Nicolas Ramirez, Denver, CO (US)

(72) Inventor: Nicolas Ramirez, Denver, CO (US)

(21) Appl. No.: 18/136,150

(22) Filed: Apr. 18, 2023

(51) Int. Cl. E06C 7/00; E06C 1/20; E06C 7/08; E06C 7/14; E06C 7/16; E06C 7/46; E06C 7/48

(52) U.S. Cl. CPC E06C 7/00; E06C 1/20; E06C 7/08; E06C 7/14; E06C 7/16; E06C 7/46; E06C 7/48; G06F 3/162

(57) ABSTRACT

A ladder and entertainment combination system for reaching high areas and playing audio files includes a ladder assembly with a cap, a front support, and a rear support. The cap is coupled to the front support and the rear support. The rear support is pivotally coupled to the cap such that the rear support is movable toward the front support. An audio file player is mounted to the cap and is operable to play audio files.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ladder apparatuses and more particularly pertains to a new ladder apparatus for reaching high areas and playing audio files.

### (2) Description of Related Art Including Information Disclosed Under 37 CFR 1.97 and 1.98.

The prior art includes myriad examples of ladder apparatuses. However, the prior art fails to address a ladder apparatus which is combined with an audio file player so that a user can listen to played audio files while using or being positioned near the ladder apparatus. The prior art also fails to address a ladder apparatus with mounting features for holding tools on the ladder and a light emitter mounted to the ladder as described by the present application.

### BRIEF SUMMARY OF THE INVENTION

An embodiment of the disclosure meets the needs presented above by generally comprising a ladder assembly comprising a cap, a front support, and a rear support. The cap has a top wall and a perimeter wall is coupled to and extends away from the top wall. The front support is coupled to the cap and comprises a pair of front rails and a plurality of rungs. The pair of front rails is coupled to and extends from the cap, and the plurality of rungs is coupled to and extends between the pair of front rails. The rungs are spaced from each other. The rear support is coupled to the cap and comprises a pair of rear rails and a plurality of crossbars. The pair of rear rails is coupled to and extends from the cap, and the plurality of crossbars is coupled to and extends between the pair of rear rails. The rear support is pivotally coupled to the cap such that the rear support is movable toward and away from the front support. An audio file player is coupled to the ladder assembly and is configured to audibly emit selected audio files. The audio file player is mounted to the cap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a ladder and entertainment combination system according to an embodiment of the disclosure.

FIG. 2 is a front view of an embodiment of the disclosure.

FIG. 3 is a back view of an embodiment of the disclosure.

FIG. 4 is a first side view of an embodiment of the disclosure.

FIG. 5 is a second side view of an embodiment of the disclosure.

FIG. 6 is a detail view of a cap of a ladder assembly of an embodiment of the disclosure.

FIG. 7 is an in-use perspective view of an embodiment of the disclosure.

FIG. 8 is a first side view of an embodiment of the disclosure in a folded configuration.

FIG. 9 is a block diagram of an embodiment of the disclosure.

### DETAILED DESCRIPTION OF THE INVENTION

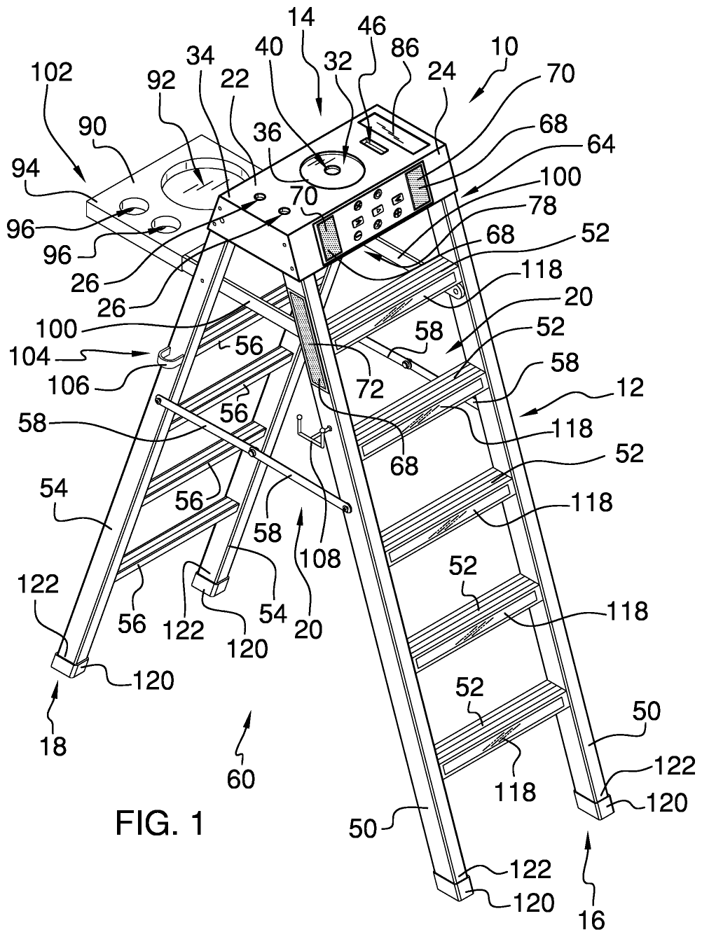

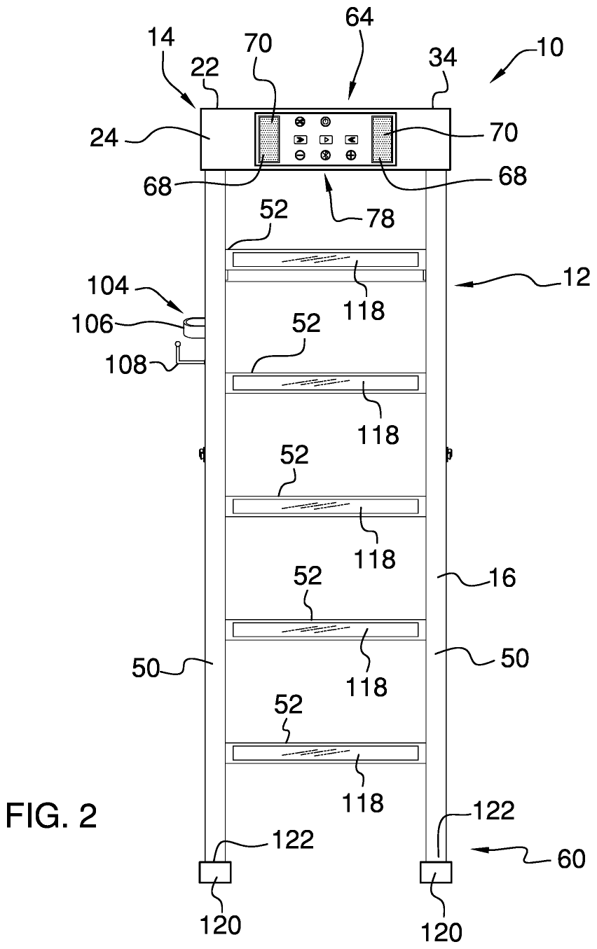

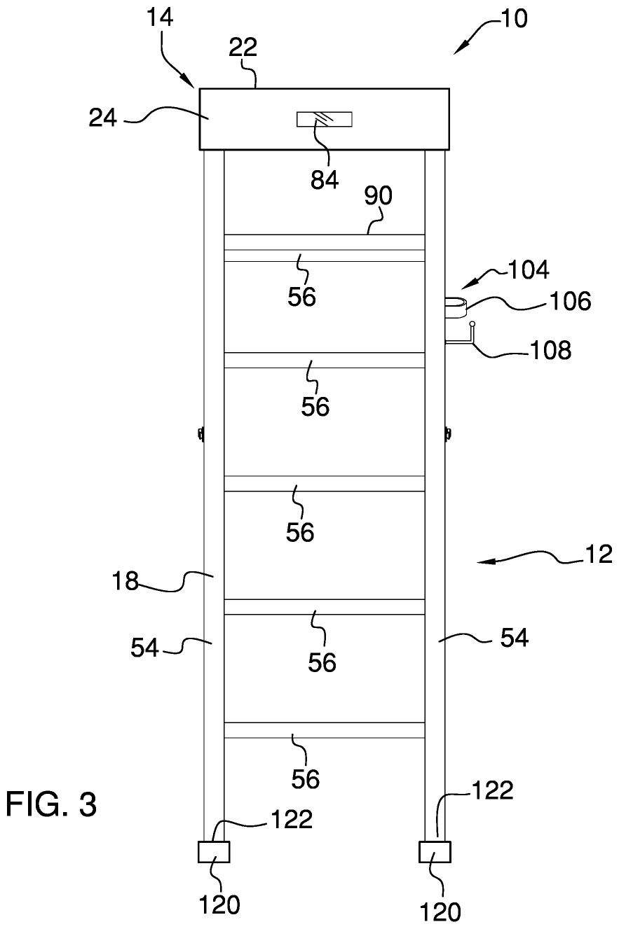

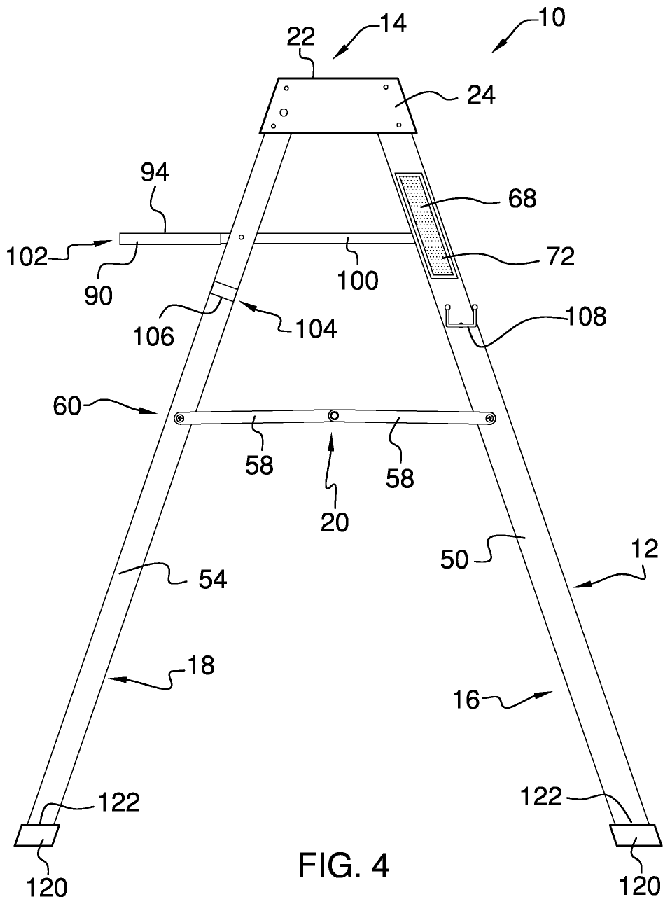

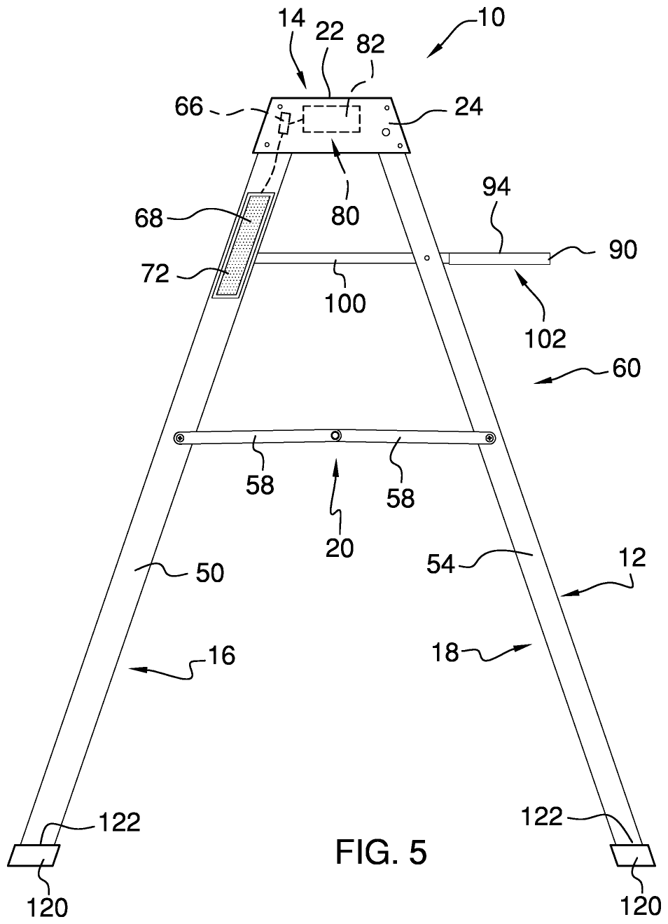

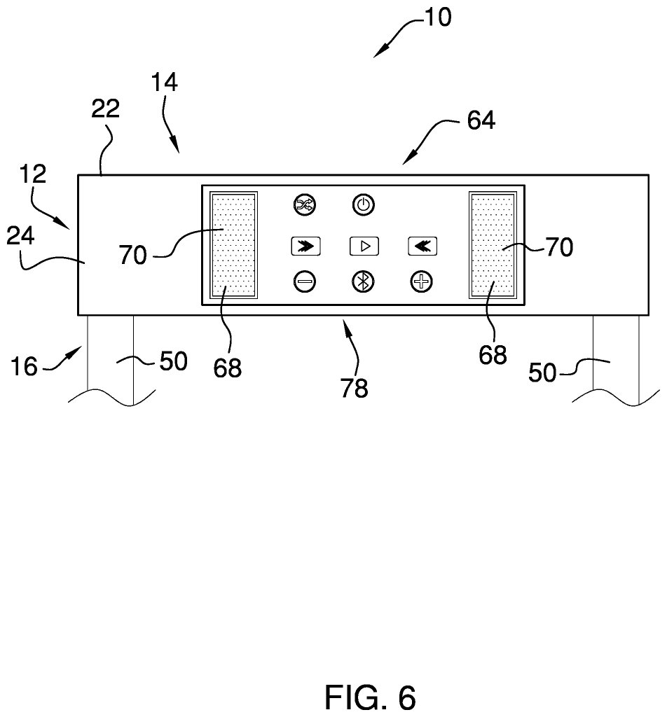

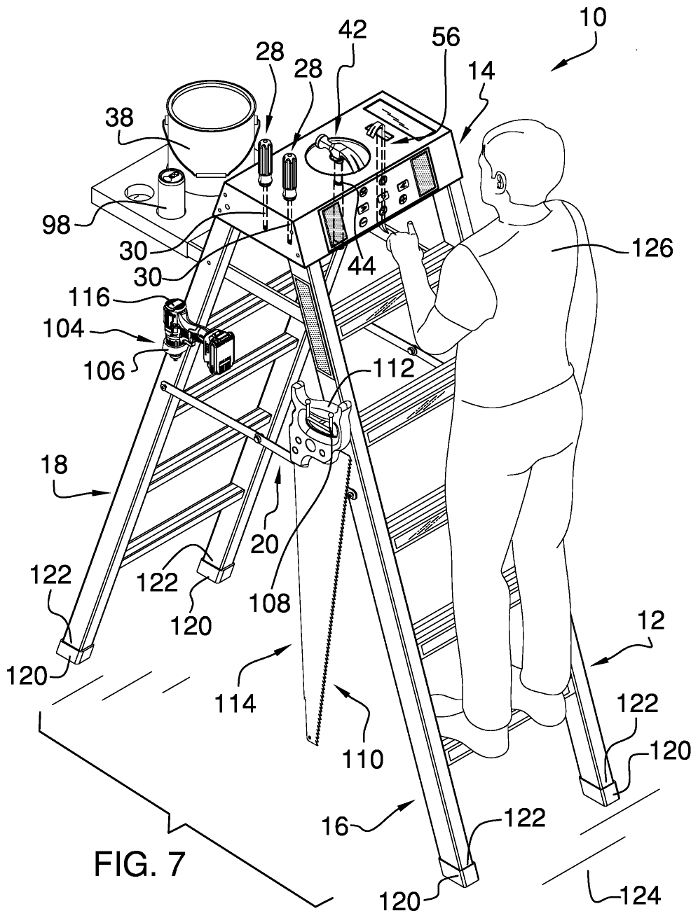

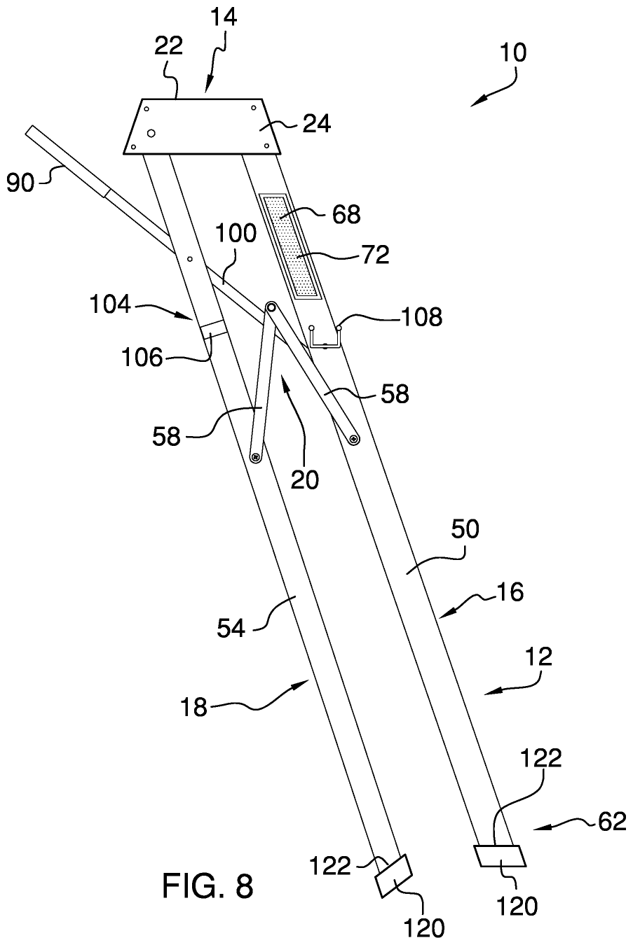

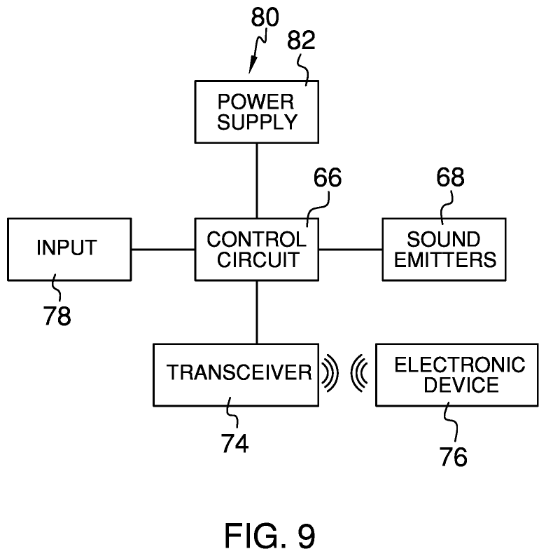

With reference now to the drawings, and in particular to FIGS. 1 through 9 thereof, a new ladder apparatus embodying the principles and concepts of an embodiment of the disclosure and generally designated by the reference numeral 10 will be described.

As best illustrated in FIGS. 1 through 9, the ladder and entertainment combination system 10 generally comprises a ladder assembly 12 comprising a cap 14, a front support 16, a rear support 18, and a pair of braces 20. The cap 14 has a top wall 22 and a perimeter wall 24 that is coupled to and extending away from the top wall 22. The top wall 22 has a pair of holes 26 extending through the top wall 22, each hole 26 of the pair holes 26 is shaped such that each hole 26 is configured for receiving a shank 30 of a screwdriver 28. The top wall 22 has a recess 32 extending into a top surface 34 of the top wall 22 and terminating in a recessed surface 36 which is configured for holding a paint can 38. The top wall 22 has an opening 40 extending through the top wall 22 and positioned on the recessed surface 36. The opening 40 is shaped such that the opening 40 is configured for receiving a handle 44 of a hammer 42. The top wall 22 has an aperture 46 extending through the top wall 22 which is shaped such that the aperture 46 is configured for receiving a portion of a crowbar 48 therethrough.

The front support 16 is coupled to the cap 14 and comprises a pair of front rails 50 and a plurality of rungs 52. The pair of front rails 50 is coupled to and extends from the cap 14, and the plurality of rungs 52 is coupled to and extends between the pair of front rails 50. The rungs 52 are spaced from each other. The rear support 18 is also coupled to the cap 14. The rear support 18 comprises a pair of rear rails 54 and a plurality of crossbars 56. The pair of rear rails 54 is coupled to and extends from the cap 14, and the plurality of crossbars 56 is coupled to and extends between the pair of rear rails 54. The rear support 18 is pivotally coupled to the cap 14 such that the rear support 18 is movable toward and away from the front support 16.

The pair of braces 20 is coupled to and extends between the front support 16 and the rear support 18. Each brace 20 comprises a pair of pivotally interconnected links 58 which are aligned to retain the front support 16 and the rear support 18 in a use condition 60. The pivotally interconnected links 58 of each brace 20 are foldable to permit the rear support 18 to pivot toward the front support 16 to a collapsed condition 62.

An audio file player 64 is coupled to the ladder assembly 12 and is configured to audibly emit selected audio files. The audio file player 64 is mounted to the cap 14. The audio file player 64 includes a control circuit 66 and a plurality of sound emitters 68. The plurality of sound emitters 68 is electrically coupled to the control circuit 66 and is coupled to the ladder assembly 12. The plurality of sound emitters 68 includes a pair of cap sound emitters 70 and a pair of rail sound emitters 72. The cap sound emitters 70 are mounted to the perimeter wall 24 of the cap 14, and each rail sound emitter 72 of the pair of rail sound emitters 72 is mounted to a respective one of the pair of front rails 50 of the front support 16.

A transceiver 74 is electrically coupled to the control circuit 66 and is configured to wirelessly communicate with an electronic device 76 having access to audio files. The transceiver 74 may communicate with the electronic device 76 through a wireless network using a Wi-Fi, Bluetooth, cellular, or like standard. An input 78 is electrically coupled to the control circuit 66 and is operable to control the control circuit 66. The input 78 is positioned on the perimeter wall 24 of the cap 14 and comprises a plurality of buttons. The input 78 may comprise a touchscreen, a voice command system, or the like. A power supply 80 is coupled to the control circuit 66 and mounted to the cap 14 and comprises a battery 82. The control circuit 66 also may receive power from an external electrical power source.

A light emitter 84 is coupled to the ladder assembly 12. The light emitter 84 is positioned on the cap 14 and is configured to emit light away from the cap 14. A magnet 86 is coupled to the cap 14 for magnetically retaining objects on the magnet 86. The magnet 86 is positioned on the top wall 22 of the cap 14. The objects to be retained on the magnet 86 may include metallic tools, fasteners, and the like. A tray 90 is pivotally coupled to and extends away from the rear support 18. The tray 90 has a cavity 92 extending into an upper surface 94 of the tray 90 which is configured for holding another paint can 38 therein. The tray 90 has at least one groove 96 extending into the upper surface 94 which is configured for holding a beverage container 98 therein. At least one arm 100 is coupled to the tray 90 and extends toward the front support 16. The at least one arm 100 engages the front support 16 to retain the tray 90 in a deployed condition 102. The front support 16 engages the at least one arm 100 to pivot downwardly and toward the rear support 18 when the rear support 18 pivots toward the front support 16, thereby causing the tray 90 to pivot upwardly and toward the rear support 18.

A tool holder 104 is coupled to one of the pair of rear rails 54. The tool holder 104 comprises a closed loop 106 has a horizontal orientation and is configured for holding a drill 116 in the closed loop 106. A tool hook 108 is coupled to one of the pair of front rails 50 and is configured for engaging a grip 112 of a tool 110. The tool 110 with the grip 112 may be, for example, a handsaw 114. A plurality of reflective members 118 is attached to the ladder assembly 12. Each rung 52 of the plurality of rungs 52 has one of the reflectively members 118 attached thereto. The reflective members 118 reflect light such that the rungs 52 are more easily viewed.

A plurality of feet 120 is attached to the ladder assembly 12. Each front rail 50 of the pair of front rails 50 and each rear rail 54 of the pair of rear rails 54 has a free end 122 positioned opposite of the cap 14. Each of the free ends 122 has one of the feet 120 attached thereto. Each foot 120 of the plurality of feet 120 is frictionally enhanced to facilitate friction between the ladder assembly 12 and a support surface 124.

In use, the ladder assembly 12 is used as a conventional step ladder. A user 126 may climb the rungs 52 of the ladder assembly 12 to reach areas too high to reach without the ladder assembly 12. The rear support 18 may be pivoted toward the front support 16 to collapse the ladder assembly 12 for storage. The audio file player 64 may be operated to play the audio files. Items such as hammers 42, screwdrivers 28, paint cans 38, and the like may be held by the various elements described more fully above.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ladder and entertainment combination system comprising:
a ladder assembly comprising:
a cap having a top wall and a perimeter wall being coupled to and extending away from the top wall;
a front support being coupled to the cap, the front support comprising a pair of front rails being coupled to and extending from the cap and a plurality of rungs being coupled to and extending between the pair of front rails, the plurality of rungs being spaced from each other;
a rear support being coupled to the cap, the rear support comprising a pair of rear rails being coupled to and extending from the cap and a plurality of crossbars being coupled to and extending between the pair of rear rails, the rear support being pivotally coupled to the cap such that the rear support is movable toward and away from the front support; and
an audio file player being coupled to the ladder assembly and being configured to audibly emit selected audio files, the audio file player being mounted to the cap.

2. The system of claim 1, wherein the top wall of the cap has a pair of holes extending through the top wall, each hole of the pair holes being shaped such that each hole is configured for receiving a shank of a screwdriver.

3. The system of claim 1, wherein the top wall of the cap has a recess extending into a top surface of the top wall and terminating in a recessed surface, the recessed surface being configured for holding a paint can.

4. The system of claim 3, wherein the top wall of the cap has an opening extending through the top wall, the opening being shaped such that the opening is configured for receiving a handle of a hammer, the opening being positioned on the recessed surface.

5. The system of claim 1, wherein the top wall of the cap has an aperture extending through the top wall, the aperture being shaped such that the aperture is configured for receiving a portion of a crowbar therethrough.

6. The system of claim 1, wherein the ladder assembly further comprises a pair of braces being coupled to and extending between the front support and the rear support, each brace comprising a pair of pivotally interconnected links aligned to retain the front support and the rear support in a use condition, the pivotally interconnected links of each brace being foldable to permit the rear support to pivot toward the front support to a collapsed condition.

7. The system of claim 1, wherein the audio file player comprises:
a control circuit;
a plurality of sound emitters being electrically coupled to the control circuit and being coupled to the ladder;
a transceiver being electrically coupled to the control circuit and being configured to wirelessly communicate with an electronic device having access to audio files;
an input being electrically coupled to the control circuit and being operable to control the control circuit, the input being positioned on the perimeter wall of the cap; and
a power supply being coupled to the control circuit and mounted to the cap, the power supply comprising a battery.

8. The system of claim 7, wherein the plurality of sound emitters including a pair of cap sound emitters being mounted to the perimeter wall of the cap, the plurality of sound emitters including a pair of rail sound emitters, each rail sound emitter of the pair of rail sound emitters being mounted to a respective one of the pair of front rails of the front support.

9. The system of claim 1, further comprising a light emitter being coupled to the ladder assembly, the light emitter being positioned on the cap and being configured to emit light away from the cap.

10. The system of claim 1, further comprising a magnet being coupled to the cap for magnetically retaining objects on the magnet, the magnet being positioned on the top wall of the cap.

11. The system of claim 1, further comprising:
a tray being pivotally coupled to and extending away from the rear support, the tray having a cavity extending into an upper surface of the tray, the cavity being configured for holding another paint can therein; and
at least one arm being coupled to the tray and extending toward the front support, the at least one arm engaging the front support to retain the tray in a deployed condition, the front support engaging the at least one arm to pivot downwardly and toward the rear support when the rear support pivots toward the front support, thereby causing the tray to pivot upwardly and toward the rear support.

12. The system of claim 11, wherein the tray has at least one groove extending into the upper surface, the groove being configured for holding a beverage container therein.

13. The system of claim 1, further comprising a tool holder being coupled to one of the pair of rear rails, the tool holder comprising a closed loop having a horizontal orientation, the tool holder being configured for holding a drill in the closed loop.

14. The system of claim 1, further comprising a tool hook being coupled to one of the pair of front rails and being configured for engaging a grip of a tool.

15. The system of claim 1, further comprising a plurality of reflective members being attached to the ladder assembly, each rung of the plurality of rungs having one of the reflectively members attached thereto.

16. The system of claim 1, further comprising a plurality of feet, each front rail of the pair of front rails and each rear rail of the pair of rear rails having a free end positioned opposite of the cap, each of the free ends having one of the feet attached thereto, each foot of the plurality of feet being frictionally enhanced to facilitate friction between the ladder assembly and a support surface.

17. A ladder and entertainment combination system comprising:
a ladder assembly comprising:
a cap having a top wall and a perimeter wall being coupled to and extending away from the top wall, the top wall having a pair of holes extending through the top wall, each hole of the pair holes being shaped such that each hole is configured for receiving a shank of a screwdriver, the top wall having a recess extending into a top surface of the top wall and terminating in a recessed surface, the recessed surface being configured for holding a paint can, the top wall having an opening extending through the top wall, the opening being shaped such that the opening is configured for receiving a handle of a hammer, the opening being positioned on the recessed surface, the top wall having an aperture extending through the top wall, the aperture being shaped such that the aperture is configured for receiving a portion of a crowbar therethrough;
a front support being coupled to the cap, the front support comprising a pair of front rails being coupled to and extending from the cap and a plurality of rungs being coupled to and extending between the pair of front rails, the plurality of rungs being spaced from each other;
a rear support being coupled to the cap, the rear support comprising a pair of rear rails being coupled to and extending from the cap and a plurality of crossbars being coupled to and extending between the pair of rear rails, the rear support being pivotally coupled to the cap such that the rear support is movable toward and away from the front support; and
a pair of braces being coupled to and extending between the front support and the rear support, each brace comprising a pair of pivotally interconnected links aligned to retain the front support and the rear support in a use condition, the pivotally interconnected links of each brace being foldable to permit the rear support to pivot toward the front support to a collapsed condition;
an audio file player being coupled to the ladder assembly and being configured to audibly emit selected audio files, the audio file player being mounted to the cap, the audio file player comprising:
a control circuit;
a plurality of sound emitters being electrically coupled to the control circuit and being coupled to the ladder, the plurality of sound emitters including a pair of cap sound emitters being mounted to the perimeter wall of the cap, the plurality of sound emitters including a pair of rail sound emitters, each rail sound emitter of the pair of rail sound emitters being mounted to a respective one of the pair of front rails of the front support;
a transceiver being electrically coupled to the control circuit and being configured to wirelessly communicate with an electronic device having access to audio files;
an input being electrically coupled to the control circuit and being operable to control the control circuit, the input being positioned on the perimeter wall of the cap; and
a power supply being coupled to the control circuit and mounted to the cap, the power supply comprising a battery;
a light emitter being coupled to the ladder assembly, the light emitter being positioned on the cap and being configured to emit light away from the cap;
a magnet being coupled to the cap for magnetically retaining objects on the magnet, the magnet being positioned on the top wall of the cap;
a tray being pivotally coupled to and extending away from the rear support, the tray having a cavity extending into an upper surface of the tray, the cavity being configured for holding another paint can therein, the tray having at least one groove extending into the upper surface, the groove being configured for holding a beverage container therein;
at least one arm being coupled to the tray and extending toward the front support, the at least one arm engaging the front support to retain the tray in a deployed condition, the front support engaging the at least one arm to pivot downwardly and toward the rear support when the rear support pivots toward the front support, thereby causing the tray to pivot upwardly and toward the rear support;
a tool holder being coupled to one of the pair of rear rails, the tool holder comprising a closed loop having a horizontal orientation, the tool holder being configured for holding a drill in the closed loop;
a tool hook being coupled to one of the pair of front rails and being configured for engaging a grip of a tool;
a plurality of reflective members being attached to the ladder assembly, each rung of the plurality of rungs having one of the reflectively members attached thereto; and
a plurality of feet, each front rail of the pair of front rails and each rear rail of the pair of rear rails having a free end positioned opposite of the cap, each of the free ends having one of the feet attached thereto, each foot of the plurality of feet being frictionally enhanced to facilitate friction between the ladder assembly and a support surface.
